(19) United States
(12) Patent Application Publication
(10) Pub. No.: US 2024/0262322 A1
(43) Pub. Date: Aug. 8, 2024

(54) CONTROL SYSTEMS AND METHODS BASED ON SENSED TRAILER HITCH LOAD

(71) Applicant: GM GLOBAL TECHNOLOGY OPERATIONS LLC, Detroit, MI (US)

(72) Inventor: Brian V. CASTILLO, Birmingham, MI (US)

(21) Appl. No.: 18/106,809

(22) Filed: Feb. 7, 2023

(51) Int. Cl. B60T 7/20; B60D 1/06; B60D 1/24; B60T 8/18

(52) U.S. Cl. CPC B60T 7/20; B60D 1/06; B60D 1/248; B60T 8/1837

(57) ABSTRACT

A trailering system of a vehicle includes: a trailer hitch configured to receive a ball, the ball configured to be coupled to trailers for towing; a force sensor configured to measure at least one of: a first force on the trailer hitch in a longitudinal direction of the vehicle; a second force on the trailer hitch in a latitudinal direction of the vehicle; and a third force on the trailer hitch in a vertical direction; and a display module configured to selectively indicate a present condition of a trailer that is coupled to the trailer hitch based on the at least one of the first force, the second force, and the third force.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle control systems and more particularly to systems and methods for controlling vehicle actuators based on measured trailer hitch load.

Vehicles include one or more torque producing devices, such as an internal combustion engine and/or an electric motor. A passenger of a vehicle rides within a passenger cabin (or passenger compartment) of the vehicle.

Vehicles may include one or more different type of sensors that sense vehicle surroundings. One example of a sensor that senses vehicle surroundings is a camera configured to capture images of the vehicle surroundings. Examples of such cameras include forward-facing cameras, rear-facing cameras, and side facing cameras. Another example of a sensor that senses vehicle surroundings includes a radar sensor configured to capture information regarding vehicle surroundings. Other examples of sensors that sense vehicle surroundings include sonar sensors and light detection and ranging (LIDAR) sensors configured to capture information regarding vehicle surroundings.

A trailer hitch may be attached to a vehicle to allow the vehicle to tow items. Examples of towable items include trailers, boats, and other items.

### SUMMARY

In a feature, a trailering system of a vehicle includes: a trailer hitch configured to receive a ball, the ball configured to be coupled to trailers for towing; a force sensor configured to measure at least one of: a first force on the trailer hitch in a longitudinal direction of the vehicle; a second force on the trailer hitch in a latitudinal direction of the vehicle; and a third force on the trailer hitch in a vertical direction; and a display module configured to selectively indicate a present condition of a trailer that is coupled to the trailer hitch based on the at least one of the first force, the second force, and the third force.

In further features, a ratio module is configured to, based on the third force, determine a ratio of a tongue mass of the trailer to a mass of the trailer, where the display module is configured to selectively indicate the present condition of the trailer that is coupled to the trailer hitch based on the ratio.

In further features, the display module is configured to indicate the present condition of the trailer when the ratio is greater than a predetermined value.

In further features, a trailer mass module is configured to determine a mass of the trailer, where the display module is further configured to indicate whether a towing capacity of the vehicle is exceeded based on the mass of the trailer.

In further features, the display module is configured to indicate that the towing capacity of the vehicle is exceeded when the mass of the trailer is greater than a predetermined mass.

In further features, a system mass module is configured to determine a mass of the combination of the vehicle and the trailer, where the trailer mass module is configured to determine the mass of the trailer based on (a) the mass of the combination of the vehicle and the trailer and (b) a predetermined mass of the vehicle.

In further features, the system mass module is configured to determine the mass of the combination of the vehicle and the trailer based on (a) a tractive force of the vehicle and (b) an acceleration of the vehicle.

In further features, the display module is configured to selectively indicate the present condition of the trailer that is coupled to the trailer hitch based on a comparison of the third force and a predetermined maximum force.

In further features, the display module is configured to indicate that a loading of the trailer is exceeded when the third force is greater than the predetermined maximum force.

In further features: a gain module is configured to selectively adjust a trailer brake gain based on the first force; and an actuator control module is configured to actuate brakes of the trailer that is coupled to the trailer hitch based on the trailer brake gain.

In further features, the gain module is configured to adjust the trailer brake gain when the brakes of the trailer are being applied.

In further features, the gain module is configured to adjust the trailer brake gain based on at least two of (a) the first force, (b) a mathematical derivative of the first force, and (c) a mathematical integral of the first force.

In further features, the display module is configured to indicate the present condition of the trailer that is coupled to the trailer hitch based on the second force.

In further features, the display module is configured to indicate the present condition of the trailer that is coupled to the trailer hitch based on an average of the second force over a predetermined period.

In further features, the display module is configured to indicate the present condition of the trailer when an absolute value of the average is greater than a predetermined force.

In further features, the display module is configured to indicate that a left side of the trailer has a condition when the average is one of positive and negative.

In further features, the display module is configured to indicate that a right side of the trailer has a condition when the average is other one of positive and negative.

In further features, an actuator control module is configured to selectively actuate one or more brakes of the trailer that is coupled to the trailer hitch based on the average.

In further features, the actuator control module is configured to selectively actuate one or more brakes of the trailer that is coupled to the trailer hitch when an absolute value of the average is greater than a predetermined value.

In a feature, a trailering method for a vehicle includes: by a force sensor, measuring at least one of: a first force on a trailer hitch in a longitudinal direction of the vehicle; a second force on the trailer hitch in a latitudinal direction of the vehicle; and a third force on the trailer hitch in a vertical direction, the trailer hitch configured to receive a ball, the ball configured to be coupled to trailers for towing; and selectively indicating a present condition of a trailer that is coupled to the trailer hitch based on the at least one of the first force, the second force, and the third force.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system;

FIG. 2 is a perspective view of an example implementation of a trailer hitch 204;

FIG. 3 is a functional block diagram of an example implementation of the trailer brake control module;

FIG. 4 is a flowchart depicting an example method of indicating whether a ratio is loading of the trailer is acceptable and whether the towing capacity of the vehicle is exceeded;

FIG. 5 is a flowchart depicting an example method of indicating whether the maximum tongue force is exceeded;

FIG. 6 is a functional block diagram of the example implementation of the trailer brake control module of FIG. 3;

FIG. 7 is a flowchart depicting an example method of controlling braking of a trailer being towed; and

FIG. 8 is a flowchart depicting an example method of indicating whether rolling resistance of the trailer's wheels is not symmetric left to right.

In the drawings, reference numbers may be reused to identify similar and/or identical elements.

### DETAILED DESCRIPTION

Various types of vehicles can be used to tow trailers, such as cars, hatchbacks, utility vehicles, trucks, etc. A vehicle may include a trailer hitch, mounted to the structure of the vehicle. A trailer tongue may be mounted to the hitch, and a ball can be affixed to the tongue to enable the attachment of a trailer for towing by the vehicle.

The present application involves one or more force sensors measuring one or more forces in different directions on the trailer hitch. The measurements can be used for better control and/or diagnostics regarding trailering, such as diagnosing overloading of the trailer, diagnosing improper loading of the trailer, diagnosing dragging of wheels of the trailer, and to adjust braking of the trailer.

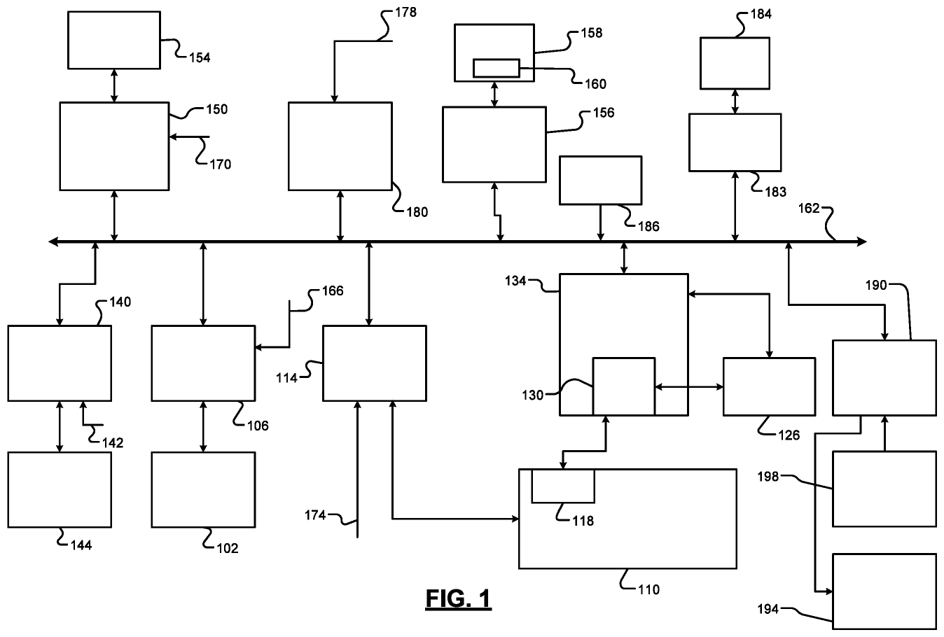

Referring now to FIG. 1, a functional block diagram of an example vehicle system is presented. While a vehicle system for a hybrid vehicle is shown and will be described, the present application is also applicable to non-hybrid vehicles, electric vehicles, fuel cell vehicles, and other types of vehicles. The present application is applicable to autonomous vehicles, semi-autonomous vehicles, non-autonomous vehicles, shared vehicles, non-shared vehicles, and other types of vehicles.

An engine 102 may combust an air/fuel mixture to generate drive torque. An engine control module (ECM) 106 controls the engine 102. For example, the ECM 106 may control actuation of engine actuators, such as a throttle valve, one or more spark plugs, one or more fuel injectors, valve actuators, camshaft phasers, an exhaust gas recirculation (EGR) valve, one or more boost devices, and other suitable engine actuators. In some types of vehicles (e.g., electric vehicles), the engine 102 may be omitted.

The engine 102 may output torque to a transmission 110. A transmission control module (TCM) 114 controls operation of the transmission 110. For example, the TCM 114 may control gear selection within the transmission 110 and one or more torque transfer devices (e.g., a torque converter, one or more clutches, etc.).

The vehicle system may include one or more electric motors. For example, an electric motor 118 may be implemented within the transmission 110 as shown in the example of FIG. 1. An electric motor can act as either a generator or as a motor at a given time. When acting as a generator, an electric motor converts mechanical energy into electrical energy. The electrical energy can be, for example, used to charge a battery 126 via a power control device (PCD) 130. When acting as a motor, an electric motor generates torque that may be used, for example, to supplement or replace torque output by the engine 102. While the example of one electric motor is provided, the vehicle may include zero or more than one electric motor.

A power inverter module (PIM) 134 may control the electric motor 118 and the PCD 130. The PCD 130 applies power from the battery 126 to the electric motor 118 based on signals from the PIM 134, and the PCD 130 provides power output by the electric motor 118, for example, to the battery 126. The PIM 134 may include, for example, an inverter.

A steering control module 140 controls steering/turning of wheels of the vehicle, for example, based on driver turning of a steering wheel within the vehicle and/or steering commands from one or more vehicle control modules. A steering wheel angle (SWA) sensor (not shown) monitors rotational position of the steering wheel and generates a SWA 142 based on the position of the steering wheel. As an example, the steering control module 140 may control vehicle steering via an electronic power steering (EPS) motor 144 based on the SWA 142. However, the vehicle may include another type of steering system.

A brake control module 150 may selectively control (e.g., friction) brakes 154 of the vehicle based on one or more driver inputs, such as a brake pedal position (BPP) 170. A damper control module 156 controls damping of dampers 158 of the wheels, respectively, of the vehicle. The dampers 158 damp vertical motion of the wheels. The damper control module 156 may control, for example, damping coefficients of the dampers 158, respectively. For example, the dampers 158 may include magnetorheological dampers, continuous damping control dampers, or another suitable type of adjustable damper. The dampers 158 include actuators 160 that adjust damping of the dampers 158, respectively. In the example of magnetorheological dampers, the actuators 160 may adjust magnetic fields applied to magnetorheological fluid within the dampers 158, respectively, to adjust damping.

Modules of the vehicle may share parameters via a network 162, such as a controller area network (CAN). A CAN may also be referred to as a car area network. For example, the network 162 may include one or more data buses. Various parameters may be made available by a given module to other modules via the network 162.

The driver inputs may include, for example, an accelerator pedal position (APP) 166 which may be provided to the ECM 106. The BPP 170 may be provided to the brake control module 150. A position 174 of a park, reverse, neutral, drive lever (PRNDL) may be provided to the TCM 114. An ignition state 178 may be provided to a body control module (BCM) 180. For example, the ignition state 178 may be input by a driver via an ignition key, button, or switch. At a given time, the ignition state 178 may be one of off, accessory, run, or crank.

An infotainment module 183 may output various information via one or more output devices 184. The output devices 184 may include, for example, one or more displays (non-touch screen and/or touch screen), one or more other suitable types of video output devices, one or more speakers, one or more haptic devices, and/or one or more other suitable types of output devices.

The infotainment module 183 may output video via the one or more displays. The infotainment module 183 may output audio via the one or more speakers. The infotainment module 183 may output other feedback via one or more haptic devices. For example, haptic devices may be included with one or more seats, in one or more seat belts, in the steering wheel, etc. Examples of displays may include, for example, one or more displays (e.g., on a front console) of the vehicle, a head up display (HUD) that displays information via a substrate (e.g., windshield), one or more displays that drop downwardly or extend upwardly to form panoramic views, and/or one or more other suitable displays.

The vehicle may include a plurality of external sensors and cameras, generally illustrated in FIG. 1 by 186. One or more actions may be taken based on input from the external sensors and cameras 186. For example, the infotainment module 183 may display video, various views, and/or alerts on a display via input from the external sensors and cameras 186 during driving.

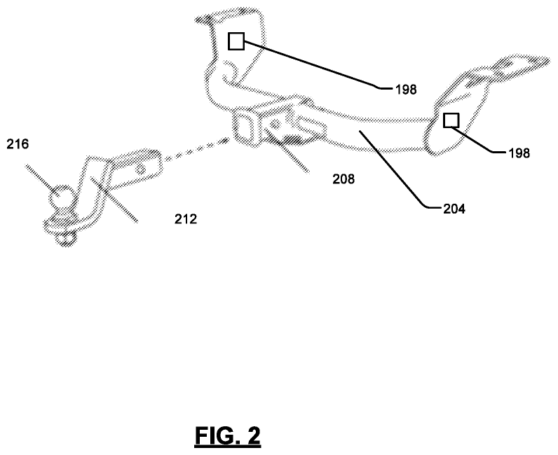

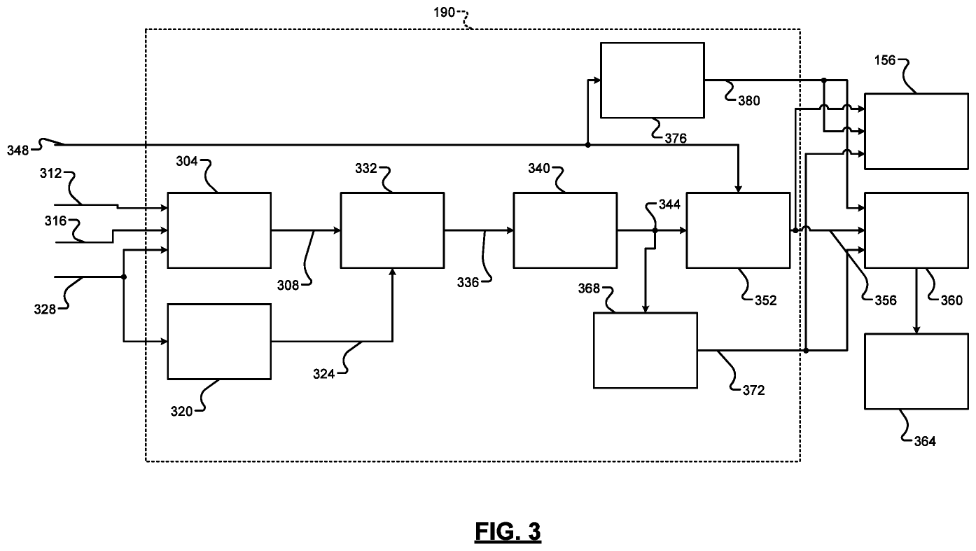

A trailer hitch and ball (e.g., see FIG. 2) can be fixed to the vehicle, such as via bolts to a frame, to accommodate the mounting of a trailer tongue 212 and ball 216. A trailer brake control module 190 (see FIG. 3) may control actuation of trailer brake actuators 194 of a trailer hitched to the vehicle based on one or more inputs, such as X direction, Y direction, and/or Z direction force on the trailer hitch. Actuation of the trailer brake actuators 194 may apply mechanical (friction) brakes of the trailer. The X, Y, and Z direction forces may be measured by one or more trailer hitch force sensors 198. The (positive) X direction force may refer to force on the trailer hitch in a backward direction of the vehicle. The (positive) Y direction force may refer to a force on the trailer hitch in a right direction of the vehicle. The (positive) Z direction force may refer to force on the trailer hitch in a vertical (up/down) direction at the trailer hitch. Z direction force in the vertically downward direction may be negative when measured by the hitch force sensors 198. Any of the forces so measured may be positive or negative in value, depending on the direction of the force. Also, while the above positive and negative direction examples are provided, the present application is also applicable to other X, Y, and/or Z direction forces.

The vehicle may include one or more additional control modules that are not shown, such as a chassis control module, a battery pack control module, etc. The vehicle may omit one or more of the control modules shown and discussed. Also, the vehicle may include one or more other types of sensors.

FIG. 2 is a perspective view of an example implementation of a trailer hitch 204. As illustrated, the force sensors 198 may be coupled to or integrated within the trailer hitch 204. The force sensors 198 may be, for example, strain gauges or another suitable type of load sensors. Multiple force sensors may be implemented, for example, for redundancy. The force sensors 198 are configured to measure forces in the X, Y, and Z directions independently.

A trailer ball 216 may be coupled to the trailer hitch 204 via a tongue 212 inserted and affixed in an aperture 208. Trailer tongues provide a way of removeably installing trailer balls to a trailer hitch 204 for the attachment and towing of the trailers.

FIG. 3 is a functional block diagram of an example implementation of the trailer brake control module 190. While the example of the trailer brake control module 190 is provided, the modules shown and described may be implemented in one or more other modules.

A tractive force module 304 determines a present tractive force 308 of the vehicle (e.g., for propulsion of the vehicle forward while towing a trailer). In the example of a pure electric vehicle, the tractive force module 304 may determine the tractive force 308, for example, based on a present current 312 to the electric motor 118, the relationship between motor current, motor speed 316, and motor torque, and the radius of the vehicle's tires. For example, the tractive force module 304 may determine the tractive force 308 using a lookup table or an equation that relates motor currents, motor speed, and motor torques to tractive forces. The current 312 and the motor speed 316 may be, for example, measured using sensors or determined based on one or more other parameters. In the example of a hybrid vehicle or a non-hybrid vehicle, the tractive force module 304 may determine the tractive force 308 based on a present torque output of the engine 102.

An acceleration module 320 determines a present acceleration 324 of the vehicle based on a sequential series of measurements of speed 328 of the vehicle (vehicle speed). The acceleration module 320 may determine the present acceleration 324, for example, based on a mathematical derivative of the vehicle speed 328. The vehicle speed may be, for example, determined based on one or more wheel speeds, such as based on an average the speeds of driven wheels of the vehicle.

A system mass module 332 determines a system inertial mass 336 of a combination of the vehicle and the trailer being towed based on the tractive force 308 and the acceleration 324. The system mass module 332 may determine the system inertial mass 336 using one or more equations or lookup tables that relate forces and accelerations to mass. For example, the system mass module 332 may set the system inertial mass 336 based on or equal to the tractive force 308 divided by the acceleration 324. The system inertial mass 336 includes both a mass of the vehicle and a mass of the trailer being towed.

A trailer mass module 340 determines a trailer inertial mass 344 of the trailer being towed based on the system inertial mass 336 and a mass of the vehicle. The trailer mass module 340 may determine the trailer inertial mass 344 using one or more equations or lookup tables that relate system masses and vehicle masses to trailer mass. For example, the trailer mass module 340 may set the trailer inertial mass 344 based on or equal to the system inertial mass 336 minus the vehicle mass. The mass of the vehicle may be a predetermined value or may be determined based on one or more parameters.

Based on a Z direction force 348 on the trailer hitch and the trailer inertial mass 344, a ratio module 352 determines a ratio 356 of tongue mass to inertial mass. The Z direction force 348 may be measured using one or more of the force sensors 198 and be used by the ratio module 352 determine the tongue weight. The ratio module 352 may determine the tongue-weight, for example, using an equation or a lookup table that relates Z direction forces to tongue weight. The tongue weight may increase as the Z direction force (downward) increases and vice versa. The ratio module 352 may set the ratio 356, for example, based on or equal to the tongue weight divided by the trailer inertial mass 354. The result may be multiplied by 100 to provide a percent in various implementations.

A display module 360 (e.g., of the infotainment module 183) controls what is displayed on a display 364 (e.g., one of the output devices 184). For example, based on the ratio 356, the display module 360 may output an indicator on the display 364 indicator of whether the loading of the trailer is ok (e.g., with a fraction of total weight supported by the tongue) or not ok (e.g., with a fraction of total weight supported by the tongue). For example, the display module 360 may display an indicator on the display 364 that the loading of the trailer is ok when the ratio 356 is greater than a predetermined value. The predetermined value may be calibrated and may be, for example, approximately 0.15 (or 15%) or another suitable value. The display module 360 may display an indicator that the loading of the trailer is not ok when the ratio 356 is less than the predetermined value.

A first comparison module 368 may output an indicator 372 based on a comparison of the trailer inertial mass 344 with a maximum (e.g., permissible) trailer mass. The maximum trailer mass may be a predetermined value and stored. The maximum trailer mass may be a maximum mass that can be towed by the vehicle, or may be calculated with other included variables, such as whether the attached trailer includes trailer brakes. The first comparison module 368 may set the indicator 372 to a first state when the trailer inertial mass 344 is less than the maximum trailer mass. The first comparison module 368 may set the indicator 372 to a second state when the trailer inertial mass 344 is greater than the maximum trailer mass.

Additionally or alternatively to the above, based on the indicator 372, the display module 360 may output an indicator on the display 364 of whether the towing capacity of the vehicle is exceeded. For example, the display module 360 may display the indicator on the display 364 that towing capacity of the vehicle is exceeded when the indicator 372 is in the second state. The display module 360 may display an indicator that the towing capacity of the vehicle is not exceeded when the indicator 372 is in the first state.

A second comparison module 376 may output an indicator 380 based on a comparison of the Z direction force 348 (downward) on the trailer hitch with a maximum tongue weight. The maximum tongue weight may be a predetermined value and stored. The maximum tongue force may be a maximum downward force on the trailer hitch allowable from trailer tongues. The second comparison module 376 may set the indicator 380 to a first state when the Z direction force 348 is less than the maximum tongue force. The second comparison module 376 may set the indicator 380 to a second state when the Z direction force 348 is greater than the maximum tongue force.

Additionally or alternatively to the above, based on the indicator 380, the display module 360 may output an indicator on the display 364 of whether the maximum tongue force is exceeded. For example, the display module 360 may display the indicator on the display 364 that maximum tongue force is exceeded when the indicator 380 is in the second state. The display module 360 may display an indicator that the maximum tongue force is not exceeded when the indicator 380 is in the first state.

In various implementations, one or more other actions may be taken when at least one of the ratio 356 is loading of the trailer is not ok, the towing capacity of the vehicle is exceeded, and the maximum tongue force is exceeded. For example, the damper control module 156 may adjust one or more damping characteristics of one or more of the dampers 158 when at least one of the ratio 356 is loading of the trailer is not ok, the towing capacity of the vehicle is exceeded, and the maximum tongue force is exceeded. Additionally or alternatively, the ECM 106 may limit the vehicle speed to a predetermined speed when the towing capacity of the vehicle is exceeded.

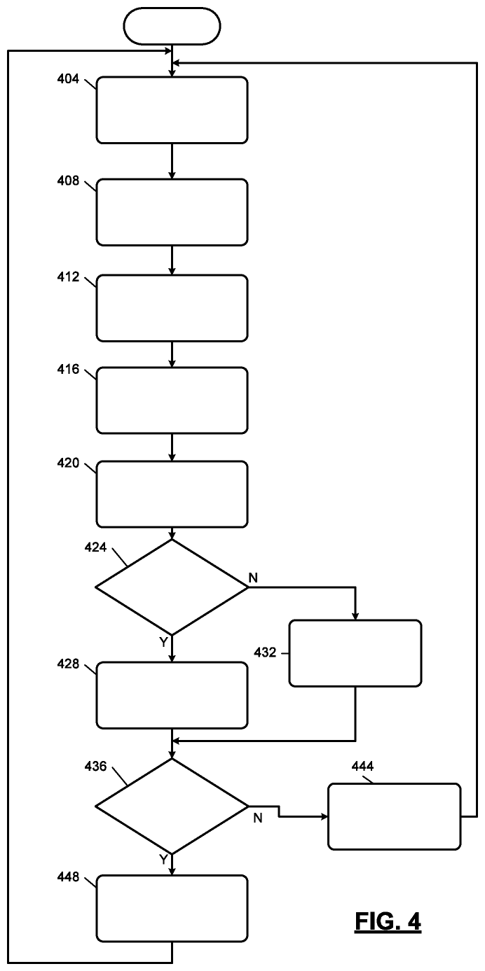

FIG. 4 is a flowchart depicting an example method of indicating whether the ratio 356 of loading of the trailer is ok and whether the towing capacity of the vehicle is exceeded. Control begins with 404 where the tractive force module 304 determines the present tractive force 308 of the vehicle. At 408, the acceleration module 320 determines the present acceleration 324 of the vehicle.

At 412, the system mass module 332 determines the system inertial mass 336. At 416, the trailer mass module 340 determines the trailer inertial mass 344. The ratio module 352 determines the ratio 356 of the tongue weight to the trailer inertial mass 344.

At 424, the display module 360 determines whether the ratio 356 is less than the predetermined value. If 424 is true, the display module 360 displays the indicator on the display 364 that the trailer loading is not ok at 428. One or more actions may also be taken at 428. For example, the damper control module 156 may adjust one or more damping characteristics of one or more of the dampers 158. If 424 is false, the display module 360 may display an indicator on the display 364 that the trailer loading is ok at 432. Control may continue with 436 after 428 or 432. In various implementations, control may return to 404, and 436-448 may be performed in parallel (e.g., concurrently) with 404-432.

At 436, the first comparison module 368 determines whether the trailer inertial mass 344 is greater than the maximum trailer mass. If 436 is true, the first comparison module 368 may set the indicator 372 to the second state and control may continue with 448. At 448, the display module 360 may display the indicator on the display 364 that the towing capacity of the vehicle is exceeded. One or more actions may also be taken at 448. For example, the damper control module 156 may adjust one or more damping characteristics of one or more of the dampers 158. At 444, the display module 360 may display the indicator on the display 364 that the towing capacity of the vehicle is not exceeded. Control may return to 404 or 436.

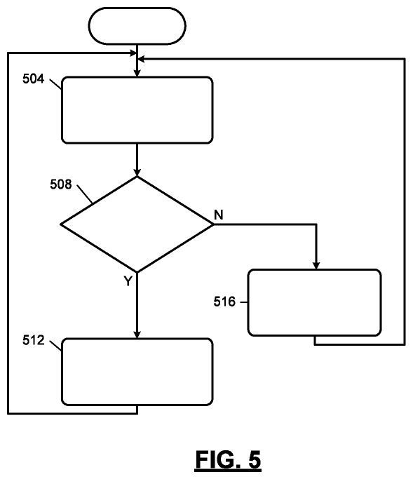

FIG. 5 is a flowchart depicting an example method of indicating whether the maximum tongue force is exceeded. Control begins with 504 where the second comparison module 376 receives the Z direction force 348.

At 508, the second comparison module 376 indicates whether the Z direction force 348 is greater than the maximum tongue (Z direction) force. If 508 is true, control continues with 512. At 512, the display module 360 may display the indicator on the display 364 that the maximum tongue force is exceeded. One or more actions may also be taken at 512. For example, the damper control module 156 may adjust one or more damping characteristics of one or more of the dampers 158. If 508 is false, control continues with 516. At 516, the display module 360 may display the indicator on the display 364 that the maximum tongue force is not exceeded. Control returns to 504.

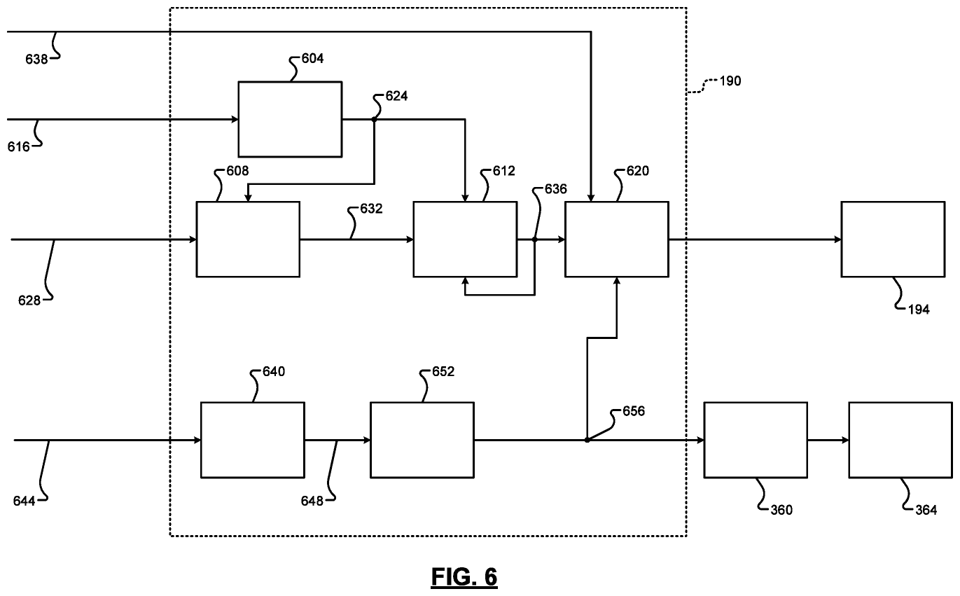

FIG. 6 is a functional block diagram including additional components of the example implementation of the trailer brake control module 190 of FIG. 3. An enabling/disabling module 604 selectively enables and disables a proportional integral derivative (PID) module 608 and a gain module 612 based on a trailer brakes indicator 616 that indicates whether the trailer brakes are presently being applied to slow the trailer. The trailer brakes indicator 616 may be set by an actuator control module 620, which is discussed further below. For example, the actuator control module 620 may set the trailer brakes indicator 616 to a first state when the actuator control module 620 is actuating trailer brakes in the absence of a brake force request 638. The actuator control module 620 may set the trailer brakes indicator 616 to a second state when the actuator control module 620 is actuating trailer brake, in the presence of a brake force request.

The enabling/disabling module 604 enables the PID module 608 and the gains module 612 when the trailer brakes indicator 616 is in the second state (when the trailer brakes are being applied). The enabling/disabling module 604 disables the PID module 608 and the gain module 612 when the trailer brakes indicator 616 is in the first state (when the trailer brakes are not being applied). The enabling/disabling module 604 may enable and disable the PID module 608 and the gains module 612 via an enabling/disabling signal 624.

The PID module 608 receives the X direction force 628 on the trailer hitch from one or more of the force sensors 198. The X direction force 628 may be the force on the trailer hitch in the forward or rearward direction of the vehicle. The PID module 608 determines a mathematical derivative of the X direction force 628 with respect to time and a mathematical integral of the X direction force 628 with respect to time. The PID module 608 applies a proportional scaling factor to the X direction force 628 to determine a weighted proportional value. For example, the PID module 608 may multiply the proportional scaling factor with the X direction force 628 to determine the proportional value. The PID module 608 applies an integral scaling factor to the integral of the X direction force 628 to determine a weighted integral value. For example, the PID module 608 may multiply the integral scaling factor with the integral to determine the integral value. The PID module 608 applies a derivative scaling factor to the derivative of the X direction force 628 to determine a derivative value. For example, the PID module 608 may multiply the derivative scaling factor with the derivative to determine the weighted derivative value.

When enabled, the PID module 608 determines an adjustment 632 based on the weighted proportional value, the weighted derivative value, and the weighted integral values. For example, the PID module 608 may set the adjustment 632 based on or equal to the weighted proportional value plus the weighted derivative value plus the weighted integral value. The PID module 608 may set the adjustment 632 to zero when disabled.

When enabled, the gain module 612 determines a gain 636 for trailer braking based on the previous value of gains 636 and the adjustment 632. For example only, the gains module 612 may set the gain 636 based on or equal to one of (a) the previous value of gain 636 plus the adjustment 632 and (b) the previous value of the gain 636 multiplied by the adjustment 632.

The actuator control module 620 actuates the trailer brake actuators 194 based on the gains 636. For example, the actuator control module 620 may actuate the trailer brakes 194 based on the gain 636 and a braking force request 638. The braking force request 638 may be a request for braking by the trailer (e.g., in the −X direction) and may be set, for example, based on the BPP 170. The actuator control module 620 may, for example, determine a final braking force request based on the gain 636 and the braking force request 638, such as by multiplying the gain 632 and the braking force request 638. The actuator control module 620 may apply the trailer brake actuators 194 such as based on achieving the final braking force request.

Additionally or alternatively, an average module 640 may receive the Y direction force 644 on the trailer hitch from one or more of the force sensors 198. Y direction force toward the left of the vehicle may be negative, and rightward may be positive. The present application, however, is also applicable to the opposite.

The average module 640 may determine an average (e.g., rolling) 648 of the Y direction force 644, such as an average of the values of the Y direction force 644 received within the last predetermined period. The predetermined period may be calibratable and may be, for example, 2 seconds or another suitable period. The average module 640 may determine the average, for example, based on a sum of all of the values received within the last predetermined period divided by the total number of the values summed.

A third comparison module 652 may determine an absolute value of the average 648. The third comparison module 652 may determine whether the absolute value of the average 648 is greater than a predetermined value. The predetermined value may be calibrated and may be, for example, 0 or another suitable value. The third comparison module 652 may set an indicator 656 to a first state when the absolute value of the average 648 is less than or equal to the predetermined value.

When the absolute value of the average 648 is greater than the predetermined value, the third comparison module 652 sets the indicator 656 based on whether the average 648 is positive or negative. This is not the absolute value of the average 648 as that value would always be positive. The third comparison module 652 sets the indicator 656 to a second state when the average 648 is positive. The third comparison module 652 sets the indicator 656 to a third state when the average 648 is negative.

Based on the indicator 656, the display module 360 may output an indicator on the display 364 of whether the Y-direction forces indicate an asymmetric fault condition (e.g., a flat tire, faulty wheel bearing, or malfunctioning brake on the trailer) occurring on the left or right side of the trailer. For example, the display module 360 may display the indicator on the display 364 that no dragging of the trailer (neither right nor left side) when the indicator 656 is in the first state. The display module 360 may display an indicator that a fault is detected is occurring on the left side of the trailer when the indicator 656 is in the second state. If the trailer is operating properly, the average Y-direction force may be close to zero. The display module 360 may display an indicator that a fault is occurring on the right side of the trailer when the indicator 656 is in the third state.

One or more actions may also be taken when the indicator 656 is in the second state or the third state. For example, the damper control module 156 may adjust one or more damping characteristics of one or more of the dampers 158. Additionally or alternatively, the actuator control module 620 may apply and release the ones of the trailer brake actuators 194 on the left side of the trailer when the indicator 656 is in the second state to try to free those ones of the trailer brake actuators 194 and stop the dragging. The actuator control module 620 may apply and release the ones of the trailer brake actuators 194 on the right side of the trailer when the indicator 656 is in the third state to try to free those ones of the trailer brake actuators 194 and stop the dragging.

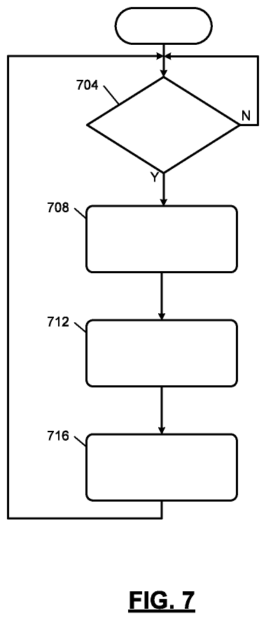

FIG. 7 is a flowchart depicting an example method of controlling braking of a trailer being towed. Control begins with 704, where the enabling/disabling module 604 determines whether the trailer brakes are presently being applied to slow the trailer. If 704 is true, control continues with 708. If 704 is false, the gain 636 may not be adjusted, and the actuator control module 620 may release trailer brake actuators 194 to not apply the trailer brakes at 716.

At 708, the PID module 608 determines the adjustment 632 based on the X direction force on the trailer hitch. At 712, the gain module 612 updates the gain 636 based on the adjustment 632 (e.g., sets the gain 636 to the previous value of the gain 636 plus the adjustment 632). At 716, the actuator control module 620 actuates the trailer brake actuators 194 based on the gain 636, such as based on the gain 636 and the braking force request 638. Control returns to 704 for a next loop.

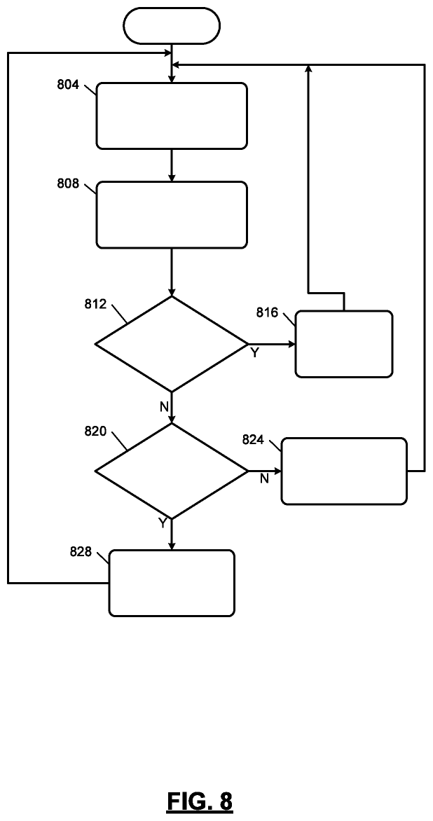

FIG. 8 is a flowchart depicting an example method of indicating whether a mechanical fault on a trailer being towed by a vehicle is occurring. Control begins with 804 where the average module 640 receives the Y direction force on the trailer hitch. At 808, the average module 640 updates the average 648 Y direction force. The third comparison module 652 determines the absolute value of the average 648.

At 812, the third comparison module 652 may determine whether the absolute value of the average 608 is less than the predetermined value. If 812 is true, the third comparison module 652 may set the indicator 656 to the third state, and control may continue with 816. At 816, the display module 360 may display an indicator on the display 364 that no fault is detected. If 812 is false, control may continue with 820.

At 820, the comparison module 652 may determine whether the average 648 is positive. If 820 is true, the comparison module 652 may set the indicator 656 to the second state, and control may continue with 828. If 820 is false, the comparison module 652 may set the indicator 656 to the third state, and control may continue with 824.

At 828, the display module 360 may display an indicator that a mechanical fault is occurring on the left side of the trailer when the indicator 656 is in the second state. At 824, the display module 360 may display an indicator that a mechanical fault is occurring on the right side of the trailer when the indicator 656 is in the third state.

One or more actions may also be taken when the indicator 656 is in the second state or the third state. For example, the damper control module 156 may adjust one or more damping characteristics of one or more of the dampers 158. Additionally or alternatively, the actuator control module 620 may apply and release the ones of the trailer brake actuators 194 on the left side of the trailer when the indicator 656 is in the second state to try to free those ones of the trailer brake actuators 194 and stop the dragging. The actuator control module 620 may apply and release the ones of the trailer brake actuators 194 on the right side of the trailer when the indicator 656 is in the third state to try to free those ones of the trailer brake actuators 194 and stop the dragging. Control may return to 804 for a next loop.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The present application states one or more problems that are unique to a particular technical field of trailering. The present application describes that the claimed embodiments resolve these unique issues. For example, some claims involve a trailer hitch configured to receive a ball, the ball configured to be coupled to trailers for towing; a force sensor configured to measure at least one of: a first force on the trailer hitch in a longitudinal direction of the vehicle; a second force on the trailer hitch in a latitudinal direction of the vehicle; and a third force on the trailer hitch in a vertical direction; and a display module configured to selectively indicate a present condition of a trailer that is coupled to the trailer hitch based on the at least one of the first force, the second force, and the third force. Accordingly, the claimed embodiments effectuate an improvement in the technical field of trailier.

What is claimed is:

1. A trailering system of a vehicle comprising:
a trailer hitch configured to receive a ball, the ball configured to be coupled to trailers for towing;
a force sensor configured to measure at least one of:
a first force on the trailer hitch in a longitudinal direction of the vehicle;
a second force on the trailer hitch in a latitudinal direction of the vehicle; and
a third force on the trailer hitch in a vertical direction; and
a display module configured to selectively indicate a present condition of a trailer that is coupled to the trailer hitch based on the at least one of the first force, the second force, and the third force.

2. The trailering system of claim 1 further comprising a ratio module configured to, based on the third force, determine a ratio of a tongue mass of the trailer to a mass of the trailer,
wherein the display module is configured to selectively indicate the present condition of the trailer that is coupled to the trailer hitch based on the ratio.

3. The trailering system of claim 2 wherein the display module is configured to indicate the present condition of the trailer when the ratio is greater than a predetermined value.

4. The trailering system of claim 1 further comprising a trailer mass module configured to determine a mass of the trailer,
wherein the display module is further configured to indicate whether a towing capacity of the vehicle is exceeded based on the mass of the trailer.

5. The trailering system of claim 4 wherein the display module is configured to indicate that the towing capacity of the vehicle is exceeded when the mass of the trailer is greater than a predetermined mass.

6. The trailering system of claim 4 further comprising a system mass module configured to determine a mass of the combination of the vehicle and the trailer, wherein the trailer mass module is configured to determine the mass of the trailer based on (a) the mass of the combination of the vehicle and the trailer and (b) a predetermined mass of the vehicle.

7. The trailering system of claim 6 wherein the system mass module is configured to determine the mass of the combination of the vehicle and the trailer based on (a) a tractive force of the vehicle and (b) an acceleration of the vehicle.

8. The trailering system of claim 1 wherein the display module is configured to selectively indicate the present condition of the trailer that is coupled to the trailer hitch based on a comparison of the third force and a predetermined maximum force.

9. The trailering system of claim 8 wherein the display module is configured to indicate that a loading of the trailer is exceeded when the third force is greater than the predetermined maximum force.

10. The trailering system of claim 1 further comprising:
a gain module configured to selectively adjust a trailer brake gain based on the first force; and
an actuator control module configured to actuate brakes of the trailer that is coupled to the trailer hitch based on the trailer brake gain.

11. The trailering system of claim 10 wherein the gain module is configured to adjust the trailer brake gain when the brakes of the trailer are being applied.

12. The trailering system of claim 10 wherein the gain module is configured to adjust the trailer brake gain based on at least two of (a) the first force, (b) a mathematical derivative of the first force, and (c) a mathematical integral of the first force.

13. The trailering system of claim 1 wherein the display module is configured to indicate the present condition of the trailer that is coupled to the trailer hitch based on the second force.

14. The trailering system of claim 13 wherein the display module is configured to indicate the present condition of the trailer that is coupled to the trailer hitch based on an average of the second force over a predetermined period.

15. The trailering system of claim 14 wherein the display module is configured to indicate the present condition of the trailer when an absolute value of the average is greater than a predetermined force.

16. The trailering system of claim 15 wherein the display module is configured to indicate that a left side of the trailer has a condition when the average is one of positive and negative.

17. The trailering system of claim 16 wherein the display module is configured to indicate that a right side of the trailer has a condition when the average is other one of positive and negative.

18. The trailering system of claim 13 further comprising an actuator control module configured to selectively actuate one or more brakes of the trailer that is coupled to the trailer hitch based on the average.

19. The trailering system of claim 18 wherein the actuator control module is configured to selectively actuate one or more brakes of the trailer that is coupled to the trailer hitch when an absolute value of the average is greater than a predetermined value.

20. A trailering method for a vehicle comprising:
by a force sensor, measuring at least one of:
a first force on a trailer hitch in a longitudinal direction of the vehicle;
a second force on the trailer hitch in a latitudinal direction of the vehicle; and
a third force on the trailer hitch in a vertical direction,
the trailer hitch configured to receive a ball, the ball configured to be coupled to trailers for towing; and
selectively indicating a present condition of a trailer that is coupled to the trailer hitch based on the at least one of the first force, the second force, and the third force.
